(19) United States
(12) Patent Application Publication
(10) Pub. No.: US 2015/0261783 A1
(43) Pub. Date: Sep. 17, 2015

(54) METHOD AND APPARATUS FOR STORING AND READING FILES

(71) Applicant: Tencent Technology (Shenzhen) Company Limited, Shenzhen (CN)

(72) Inventors: Panpan Hu, Shenzhen (CN); Yongsheng Liu, Shenzhen (CN); Xiyuan Li, Shenzhen (CN)

(21) Appl. No.: 14/726,367

(22) Filed: May 29, 2015

Related U.S. Application Data
(63) Continuation of application No. PCT/CN2013/088416, filed on Dec. 3, 2013.

(30) Foreign Application Priority Data
Jan. 7, 2013 (CN) 201310005203.5

(51) Int. Cl. G06F 17/30

(52) U.S. Cl. CPC G06F 17/30194; G06F 17/30091

(57) ABSTRACT

A method and apparatus for storing and reading files are provided. The method includes: dividing a file into a plurality of sections, generating a unique section key for each section, and storing a main key for the file and the plurality of sections keys as a main storage record; dividing a section into a plurality of blocks, generating a unique block value for each block within the section, generating a section value corresponding to the section key based on the plurality of block values, and storing the section key and the section value as a section storage record; and associating each block value with indexing information for the corresponding block. In accordance with the method and apparatus for storing and reading files, file indexes are stored in separate groups to increase the maximum file size and the speed for reading file indexes while reducing the cost for reading file indexes.

### CROSS-REFERENCE TO RELATED APPLICATIONS

This application is a continuation of International Patent Application No. PCT/CN2013/088416, entitled “Method and Apparatus for Storing and Reading Files,” filed on Dec. 3, 2013. This application claims the benefit and priority of Chinese Patent Application No. 201310005203.5, entitled “Method and Apparatus for Storing and Reading Files,” filed on Jan. 7, 2013. The entire disclosures of each of the above applications are incorporated herein by reference.

### TECHNICAL FIELD

The present invention relates to file storage, and more particularly to method and apparatus for storing and reading large files.

### BACKGROUND

FIG. 1 is an exemplary schematic diagram for a file storage device in an existing distributed file system. As shown in FIG. 1, large files are divided into blocks for storage in the existing distributed file system, i.e., all the data blocks of the file are distributed and stored in multiple storage records in accordance with some rules, and there is a central data management record in the file storage device that stores all the block indexing information for the file, i.e., information regarding the corresponding storage records for the blocks.

In existing distributed file systems, each file has a unique key, which has a corresponding value that contains all the block indexing information of the file. The value is stored in binary form in the file storage device. The corresponding value for the key is formed by putting all the block indexing information sequentially in a list. In searching for the indexing information for a particular block, the corresponding list of block indexing information is searched based on the key of the file, and the list is searched sequentially to find the indexing information for that particular block.

There are at least the following issues in the prior art. First, the file storage device has a limit on the size of the key, which limits the block indexing information stored in the key, and the size of the file. Second, the block indexing information increases along with the size of the files; since there is a need to search sequentially the entire list of block index information for every search, the cost in parsing and searching the list of block index information increases along with the size of the file, which affects the performance of the distributed file system.

Thus, there is a need to provide a method and apparatus for storing and reading files that addresses these issues in the prior art.

### SUMMARY OF THE INVENTION

In accordance with embodiments of the present invention, a method and apparatus for storing and reading files is provided, wherein file indexes are stored in separate groups to increase the maximum file size and the speed for reading file indexes while reducing the cost for reading file indexes. The present invention addresses several issues in existing file storage method and apparatus, including the limit on file size, slow speed and high cost for reading file indexes.

In accordance with one aspect of the present invention, a method for storing files is provided, the method comprising: dividing a file into a plurality of sections, generating a unique section key for each section, and storing a main key for the file and the plurality of sections keys as a main storage record; dividing a section into a plurality of blocks, generating a unique block value for each block within the section, generating a section value corresponding to the section key based on the plurality of block values, and storing the section key and the section value as a section storage record; and associating each block value with indexing information for the corresponding block.

In accordance with another aspect of the present invention, an apparatus for storing files is provided, comprising: a main storage record generation module for dividing a file into a plurality of sections, generating a unique section key for each section, and storing a main key for the file and the plurality of sections keys as a main storage record; a section storage record generation module for dividing a section into a plurality of blocks, generating a unique block value for each block within the section, generating a section value corresponding to the section key based on the plurality of block values, and storing the section key and the section value as a section storage record; and an association module for associating each block value with indexing information for the corresponding block.

In accordance with another aspect of the present invention, a method for reading files is provided, the method comprising: determining a main storage record in a key-value store for a file based on a main key; determining a section storage record and a section value in the key-value store based on a section key; and determining the location of indexing information of a block based on a block value of the block.

In accordance with another aspect of the present invention, an apparatus for reading files is provided, comprising: a main storage record determination module for determining a main storage record in a key-value store for a file based on a main key; a section storage record determination module for determining a section storage record and a section value in the key-value store based on a section key; and a block location determination module for determining the location of indexing information of a block based on a block value of the block.

In accordance with the method and apparatus for storing and reading files of the present invention, file indexes are stored in separate groups to increase the maximum file size and the speed for reading file indexes while reducing the cost for reading file indexes. The present invention addresses several issues in existing file storage method and apparatus, including the limit on file size, slow speed and high cost for reading file indexes.

### BRIEF DESCRIPTION OF THE DRAWINGS

FIG. 1 is an exemplary schematic diagram for a file storage apparatus in an existing distributed file system.

FIG. 2 is an exemplary flowchart for a method for storing files in accordance with a preferred embodiment of the present invention.

FIG. 3 is an exemplary schematic diagram for an apparatus for storing files in accordance with a preferred embodiment of the present invention.

FIG. 4 is an exemplary flowchart for a method for reading files in accordance with a preferred embodiment of the present invention.

FIG. 5 is an exemplary schematic diagram illustrating the operation of an apparatus for reading files in accordance with a preferred embodiment of the present invention.

FIG. 6 is an exemplary schematic diagram illustrating the operation of an apparatus for storing files in accordance with an embodiment of the present invention.

FIG. 7 is an exemplary schematic diagram illustrating the operation of an apparatus for reading files in accordance with an embodiment of the present invention.

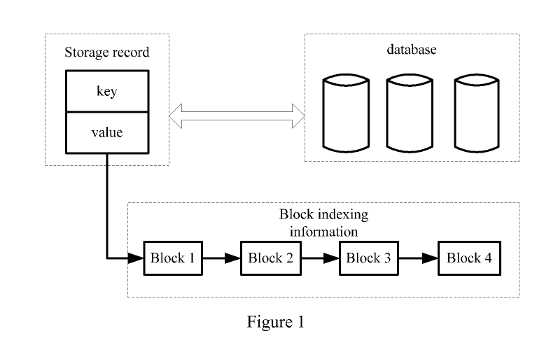

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

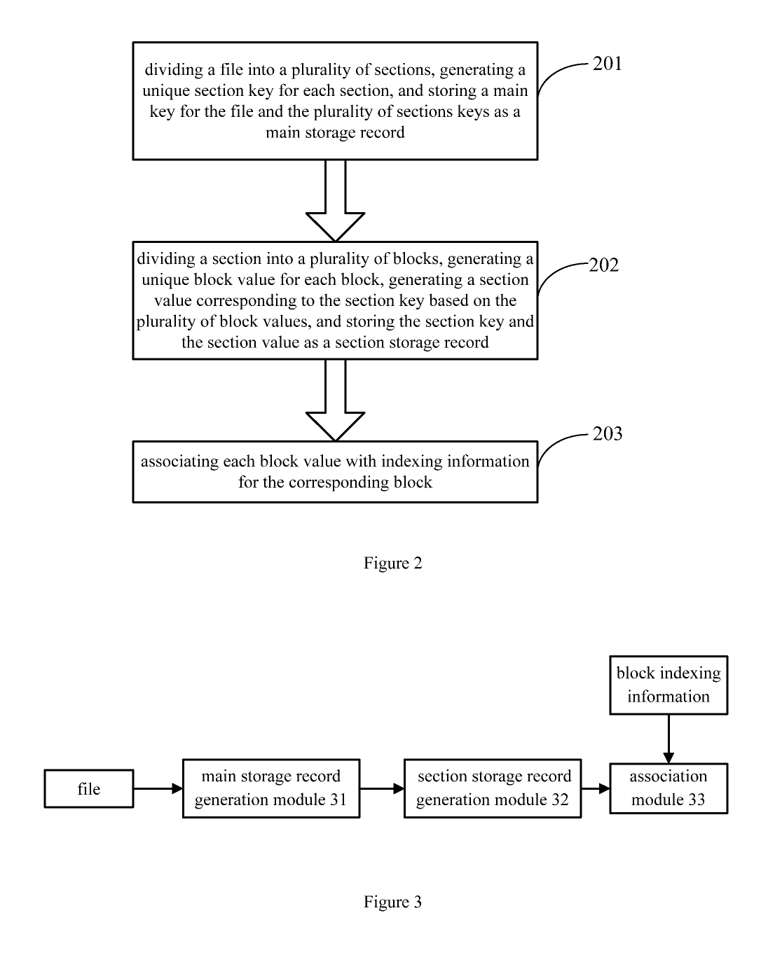

FIG. 2 is an exemplary flowchart for a method for storing files in accordance with a preferred embodiment of the present invention. As shown in FIG. 2, the method in accordance with the preferable embodiment of the present invention includes the following steps.

Step 201: dividing a file into a plurality of sections, generating a unique section key for each section, and storing a main key for the file and the plurality of sections keys as a main storage record.

Step 202: dividing a section into a plurality of blocks, generating a unique block value for each block within the section, generating a section value corresponding to the section key based on the plurality of block values, and storing the section key and the section value as a section storage record.

Step 203: associating each block value with indexing information for the corresponding block.

Step 203 concludes the method for storing files in accordance with a preferred embodiment of the present invention.

The implementation of each step in the method for storing files in accordance with a preferred embodiment of the present invention will be further described in detail below.

In step 201, a main key is set for each file, and the file is divided into a plurality of sections based on the size of the file; i.e., the bigger the file, the larger the number of sections. The size of the section can be set according to need. Subsequently, a section key within the file is generated for each section, and each section key is stored at an offset to the main key based on an offset of the section within the file. Lastly, the main key for the file and the plurality of sections keys are stored as a main storage record, wherein the main key and the plurality of section keys are stored in a distributed key-value store.

Step 202 is performed subsequently.

In step 202, a section is divided into a plurality of blocks. Subsequently, a block value unique within the section is generated for each block within the section, each block value is stored in an array at an offset to the section key based on an offset of the block within the section, and a section value corresponding to the section key is generated based on the plurality of block values. Lastly, the section key and the section value are stored as a section storage record, wherein the section key and the corresponding section value are stored in a distributed key-value store. Preferably, the main storage record and the section storage record are stored at different storage devices. Thus, in searching for a block, the main storage record can be found based on the main key, the section can be found based on the section key, and the offset of the block within the section can be found based on the block value.

Step 203 is performed subsequently.

In step 203, the block value is associated with indexing information for the corresponding block. Thus, the indexing information for locating the block can be quickly found through the main key, the section key, and the block value.

These steps complete the storing of the file.

In accordance with the method for storing files of the preferred embodiment of the present invention, file indexes are stored in separate groups to increase the maximum file size and the speed for reading file indexes while reducing the cost for reading file indexes. The block values and section keys are stored sequentially, which further reduces the time for searching the file. The section key and the corresponding section value, the main key and the plurality of section keys are all stored in a distributed NoSQL key-value store, which further enhances system reliability and scalability.

The present invention also provides an apparatus for storing files. FIG. 3 is an exemplary schematic diagram for an apparatus for storing files in accordance with a preferred embodiment of the present invention. As shown in FIG. 3, the apparatus for storing files in accordance with the preferred embodiment includes a main storage record generation module 31, a section storage record generation module 32, and an association module 33. The main storage record generation module 31 is used for dividing a file into a plurality of sections, generating a unique section key for each section, and storing a main key for the file and the plurality of sections keys as a main storage record; the section storage record generation module 32 is used for dividing a section into a plurality of blocks, generating a unique block value for each block within the section, generating a section value corresponding to the section key based on the plurality of block values, and storing the section key and the section value as a section storage record; and the association module 33 is used for associating each block value with indexing information for the corresponding block.

During the operation of the apparatus for storing files in accordance with the preferred embodiment, the main storage record generation module 31 divides a file into a plurality of sections, generates a unique section key for each section, and stores a main key for the file and the plurality of sections keys as a main storage record, wherein the main key and the plurality of section keys are stored in a distributed key-value store. Subsequently, the section storage record generation module 32 divides a section into a plurality of blocks, generates a unique block value for each block within the section, generates a section value corresponding to the section key based on the plurality of block values, and stores the section key and the section value as a section storage record, wherein the section key and the corresponding section value are stored in a distributed key-value store. Preferably, the main storage record and the section storage record are stored at different storage devices. Lastly, the association module 33 associates each block value with indexing information for the corresponding block so that the indexing information of a block can be quickly found through the main key, the section key, and the block value, which completes the storing of the file.

The operational principles of the apparatus for storing files in the present embodiment are the same or similar to those of the method for storing files in the embodiment described above, and the method embodiment can be referenced for implementation details, which will not be reiterated here.

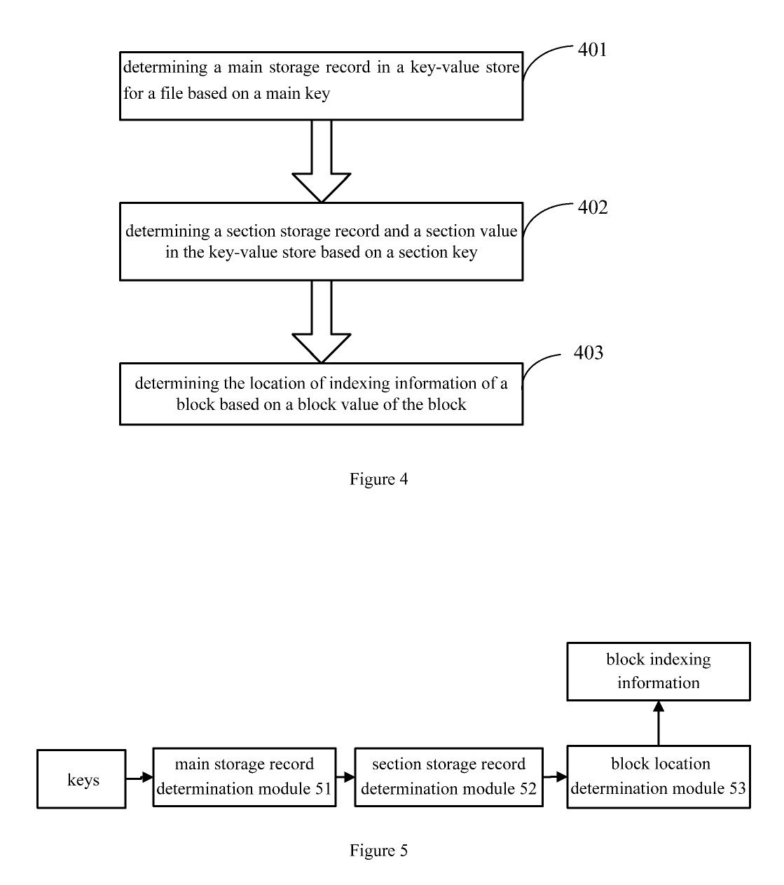

The present invention also provides method for reading files. FIG. 4 is an exemplary flowchart for a method for reading files in accordance with a preferred embodiment of the present invention. As shown in FIG. 4, the method includes the following steps.

Step 401: determining a main storage record in a key-value store for a file based on a main key.

Step 402: determining a section storage record and a section value in the key-value store based on a section key.

Step 403: determining the location of indexing information of a block based on a block value of the block.

Step 403 concludes the method for reading files in accordance with a preferred embodiment of the present invention.

The implementation of each step in the method for reading files in accordance with a preferred embodiment of the present invention will be further described in detail below.

In step 401, the file is divided into a plurality of sections based on the size of the file; each section is divided into a plurality of blocks. Thus, each block has a corresponding section that it belongs, and each section has a corresponding file that it belongs. Each block has a main key, a section key, and a block value. In this step, the main storage record is determined based on the main key.

Step 402 is performed subsequently.

In step 402: a section storage record and a section value are determined based on a section key. The main key and the corresponding section keys are stored as a main storage record, and the section key is determined based on the offset of the section within the file so that it can be found quickly to determine the corresponding section storage record and the section value. Here the section key corresponds to the section value.

Step 403 is performed subsequently

In step 403, the section key and the section value, which includes the corresponding block values, are stored as a section storage record. Preferably, the main storage record and the section storage record are read at different storage devices. The block values in the section storage record are stored as an array based on an offset of the block within the section. Thus, the block value can be found based on the offset of the block within the section, and the block value is associated with indexing information of the block. The location of indexing information of a block can be determined based on the block value, and the block can be subsequently read.

These steps complete the storing of the file.

In accordance with the method for reading files of the preferred embodiment of the present invention, file indexes are stored in separate groups to increase the speed for reading file indexes while reducing the cost for reading file indexes. The block values and section keys are stored sequentially, which further reduces the time for searching the file.

The present invention also provides an apparatus for reading files. FIG. 5 is an exemplary schematic diagram illustrating the operation of an apparatus for reading files in accordance with a preferred embodiment of the present invention. As shown in FIG. 5, the apparatus for reading files in accordance with the preferred embodiment includes a main storage record determination module 51, a section storage record determination module 52, and a block location determination module 53. The main storage record determination module 51 is used for determining a main storage record in a key-value store for a file based on a main key; the section storage record determination module 52 is used for determining a section storage record and a section value in the key-value store based on a section key; and the block location determination module 53 is used for determining the location of indexing information of a block based on a block value of the block.

During the operation of the apparatus for reading files in accordance with the preferred embodiment, the main storage record determination module 51 firstly determines a main storage record in a key-value store for a file based on a main key; the section storage record determination module 52 subsequently determines a section storage record and a section value in the key-value store based on a section key; and the block location determination module 53 lastly determines the location of indexing information of a block based on a block value of the block. These steps complete the reading of the file.

The various components described in the embodiments of the present invention, such as the main storage record determination module 51, the section storage record determination module 52, and the block location determination module 53, can be implemented as a computer processor, such as a ProLiant server from HP, a SPARC server from Sun Microsystems or a mainframe computer from IBM; and the computer processor may execute conventional or customer designed database management systems (DBMSs), such as MySQL, Microsoft SQL Server, Oracle, SAP, and IBM DB2 to implement the functions of the various components.

It should be noted that, in the above descriptions, the various modules in the apparatus are merely exemplary examples used to illustrate the embodiments of the present invention by way of examples. In practice, the various functions can be allocated to different modules based on need, and the apparatus can be divided into different modules to perform the whole or part of the functions described above. In addition, the operational principles of the apparatus embodiments are the same as or similar to those of the method methods, and the description of the method embodiments above can be referenced for the implementation details of the apparatus embodiments.

In accordance with the apparatus for reading files of the preferred embodiment of the present invention, file indexes are stored in separate groups to increase the speed for reading file indexes while reducing the cost for reading file indexes. The block values and section keys are stored sequentially, which further reduces the time for searching the file.

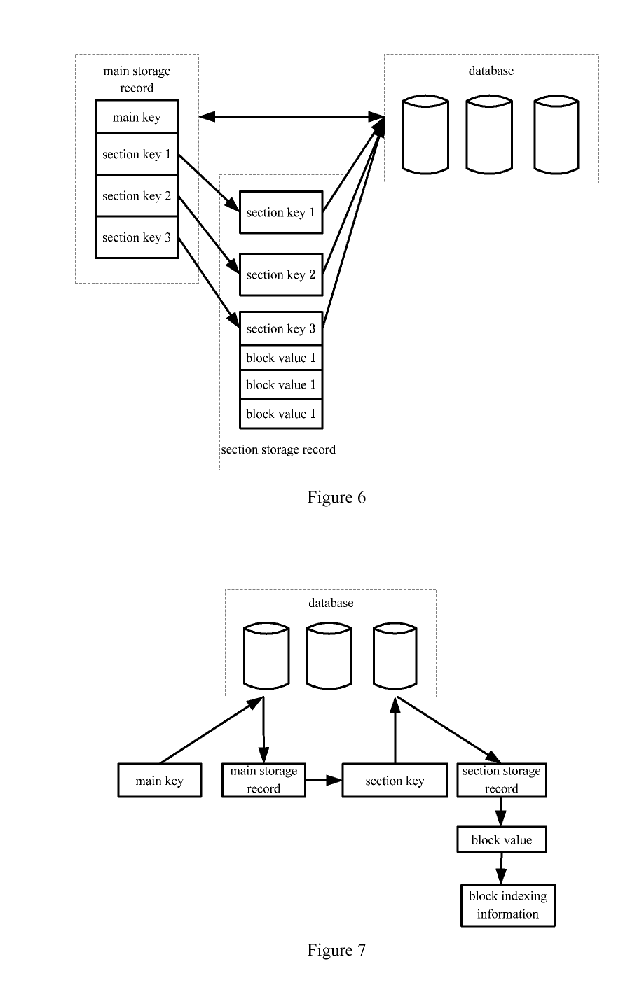

The operational principles of the method and apparatus for storing and reading large files will be further described below in connection with a specific embodiment in reference to FIGS. 6 and 7. FIG. 6 is an exemplary schematic diagram illustrating the operation of an apparatus for storing files in accordance with an embodiment of the present invention. FIG. 7 is an exemplary schematic diagram illustrating the operation of an apparatus for reading files in accordance with an embodiment of the present invention.

As shown in FIG. 6, the main storage record generation module divides a large file into three sections, and generates a section key for each section (section key 1, section key 2, and section key 3). Each section key is stored at an offset to the main key based on an offset of the section within the file, and each section key has a corresponding section value in the corresponding section storage record (section value 1, section value 2, and section value 3). The section key is applicable to all the blocks with the section. The main key and the section keys are stored as a main storage record in a distributed key-value store. The section storage record generation module divides a section into a plurality of blocks (as shown, the third section is divided into three blocks), generates a unique block value for each block within the section (such as block value 1, block value 2, and block value 3), each block values is stored in an array (or in other ways) at an offset to the section key based on the offset of the block within the section. The section key and the blocks values are subsequently stored as a section storage record in a distributed key-value store. The association module lastly associates each block value with indexing information for the corresponding block in the database.

The storage of file indexes in separate groups in accordance with the embodiments of the present invention greatly increases the maximum file size in a distributed file system. As a large file's index information can be stored under different section keys, the limitation on the length of the section key is removed, and the distributed file system can support even larger files.

In searching for a block on the apparatus for storing files in accordance with an embodiment of the present invention, as shown in FIG. 7, the main storage record is firstly found in the database based on the main key. As each section key is stored at an offset to the main key based on an offset of the section within the file, the section key can be obtained based on the offset of the requested block (i.e., the location of the block within the file, such as in the first 1M of a 10M file). The corresponding section storage record and section value can be found in the database based on the section key. As each block value is stored in an array at an offset to the section key based on an offset of the block within the section, the block value can be quickly located using the bisection method. Lastly, the location of indexing information of the block can be found based on the block value.

In searching for a block on the apparatus for storing files in accordance with an embodiment of the present invention, the indexing information for all the blocks within a section can be directly read at once after the section key is obtained based on the main key and the offset of the block within the file, and stored in an index cache system. In subsequent search for a nearby block, the corresponding indexing information can be directly obtained from the index cache system without searching the section storage record.

Thus, in searching for a block on the apparatus for storing files in accordance with an embodiment of the present invention, not all the blocks need to be parsed, and the blocks can be searched sequentially. Furthermore, the indexing information for all the blocks within a section can be pre-read into a cache, which increase the speed of searching the file and reduces the cost for searching the file.

In accordance with the method for storing files of the preferred embodiment of the present invention, file indexes are stored in separate groups to increase the maximum file size and the speed for reading file indexes while reducing the cost for reading file indexes. The block values and section keys are stored sequentially, which further reduces the time for searching the file. The section key and the corresponding section value, the main key and the plurality of section keys are all stored in a distributed key-value store, which further enhances system reliability and scalability.

Note that one or more of the functions described above can be performed by software or firmware stored in memory and executed by a processor, or stored in program storage and executed by a processor. The software or firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method for storing files, comprising:
dividing a file into a plurality of sections, generating a unique section key for each section, and storing a main key for the file and the plurality of sections keys as a main storage record;
dividing a section into a plurality of blocks, generating a unique block value for each block within the section, generating a section value corresponding to the section key based on the plurality of block values, and storing the section key and the section value as a section storage record; and
associating each block value with indexing information for the corresponding block.

2. The method of claim 1, further comprising storing the main storage record and the section storage record at different storage devices.

3. The method of claim 1, wherein the section key is stored at an offset to the main key based on an offset of the section within the file.

4. The method of claim 1, wherein each block value is stored in an array at an offset to the section key based on an offset of the block within the section.

5. The method of claim 1, wherein the section key and the corresponding section value are stored in a distributed key-value store.

6. The method of claim 1, wherein the main key and the plurality of section keys are stored in a distributed key-value store.

7. An apparatus for storing files, comprising:
a main storage record generation module configured to divide a file into a plurality of sections, generate a unique section key for each section, and store a main key for the file and the plurality of sections keys as a main storage record;
a section storage record generation module configured to dividing a section into a plurality of blocks, generate a unique block value for each block within the section, generate a section value corresponding to the section key based on the plurality of block values, and store the section key and the section value as a section storage record; and
an association module configured to associate each block value with indexing information for the corresponding block.

8. The apparatus of claim 7, wherein the main storage record and the section storage record are stored at different storage devices.

9. The apparatus of claim 7, wherein the section key is stored at an offset to the main key based on an offset of the section within the file.

10. The apparatus of claim 7, wherein each block value is stored in an array at an offset to the section key based on an offset of the block within the section.

11. The apparatus of claim 7, wherein a section key and the corresponding section value are stored in a distributed key-value store.

12. The apparatus of claim 7, wherein the main key and the plurality of section keys are stored in a distributed key-value store.

13. A method for reading files, comprising:
determining a main storage record in a key-value store for a file based on a main key;
determining a section storage record and a section value in the key-value store based on a section key; and
determining the location of indexing information of a block based on a block value of the block.

14. The method of claim 13, further comprising reading the main storage record and the section storage record at different storage devices.

15. The method of claim 13, further comprising determining the section key based on an offset of the section within the file.

16. The method of claim 13, further comprising determining the block value based on an offset of the block within the section using a bisection method.

17. An apparatus for reading files, comprising:
a main storage record determination module configured to determine a main storage record in a key-value store for a file based on a main key;
a section storage record determination module configured to determine a section storage record and a section value in the key-value store based on a section key; and
a block location determination module configured to determine the location of indexing information of a block based on a block value of the block.

18. The apparatus of claim 17, wherein the main storage record and the section storage record are stored at different storage devices.

19. The apparatus of claim 17, wherein a section key is stored at an offset to the main key based on the offset of the section within the file.

20. The apparatus of claim 17, wherein each block value is stored at an offset to the section key based on an offset of the block within the section.
